(19) United States
(12) Patent Application Publication
(10) Pub. No.: US 2020/0316706 A1
(43) Pub. Date: Oct. 8, 2020

(54) WELDING NOZZLE ASSEMBLY AND METHOD OF USE THEREOF

(71) Applicant: REFRACTORY ANCHORS, INC., Broken Arrow, OK (US)

(72) Inventors: ADRIAN LAVELL ROSS, BROKEN ARROW, OK (US); JOSEPH DUNN, BROKEN ARROW, OK (US); MICHAEL R. ORR, BROKEN ARROW, OK (US)

(73) Assignee: REFRACTORY ANCHORS, INC., Broken Arrow, OK (US)

(21) Appl. No.: 16/835,255

(22) Filed: Mar. 30, 2020

Related U.S. Application Data
(60) Provisional application No. 62/831,124, filed on Apr. 8, 2019.

(51) Int. Cl. B23K 9/173; B23K 37/06; B23K 37/04

(52) U.S. Cl. CPC B23K 9/173; B23K 2103/52; B23K 37/0426; B23K 37/06

(57) ABSTRACT

The invention relates to a welding nozzle assembly and method of use thereof. The welding nozzle assembly has a first or upper guide body and a second or lower guide body configured to accurately insert and position the nozzle assembly between two adjacent arms of a V-shaped refractory anchor assembly. The method of using the welding nozzle assembly forms a welding pool dam for attaching the V-shaped refractory anchor assembly to a surface.

### CROSS REFERENCE TO RELATED APPLICATIONS

This application claims the benefit of U.S. Provisional Patent Application No. 62/831,124 filed on Apr. 8, 2019, and incorporates said provisional application by reference in its entirety into this document as if fully set out at this point.

### BACKGROUND OF THE INVENTION

### 1. Field of the Invention

This invention relates generally to a welding nozzle assembly and method of use thereof, and more particularly to an arc welding nozzle assembly having an upper guide body and a lower guide body configured to accurately insert and position the nozzle assembly between two adjacent arms of a V-shaped refractory anchor assembly, and to a method of using the welding nozzle assembly to form a welding pool dam for attaching the V-shaped refractory anchor assembly to a surface.

### 2. Description of the Related Art

To attach refractory materials to a surface of vessels, such as furnaces, boilers, heat exchangers or other vessels requiring refractory materials, the gas metal arc welding (GMAW) process may be utilized. In North America, the GMAW process is commonly referred to as MIG (metal inert gas) welding; in Europe, the process is termed MAG (metal active gas) welding. “MIG” as used hereafter refers to both the MIG and the MAG GMAW processes. To produce these welds, either MIG spot or MIG spot plug welding techniques may be used.

A “MIG spot weld” is a timed MIG weld in which two metal components in contact are welded together. The MIG spot weld penetrates a top metal component (e.g., an anchor for a refractory material), and in doing so welds the top metal component to a bottom metal component (e.g., a surface, such as an interior surface, or a wall of a vessel).

A “MIG spot plug weld” is a timed spot weld made on a top metal component that has a bore. The top metal component is welded to a bottom component using a MIG spot plug weld. The MIG spot plug weld utilizes an electrode to provide a resulting weld that sufficiently covers the bore in the top metal component and provides sufficient weld penetration to join the top metal component to the bottom metal component. A MIG spot plug weld generally requires less energy than a spot weld because it is not necessary to penetrate two steel components. Furthermore, MIG spot plug welding generally provides welds that are stronger and more consistent than MIG spot welds.

The weld may be made using GMAW spray transfer, GMAW globular transfer or GMAW pulsed transfer. When a spray transfer mode is utilized, a 2-, 3- or 4-component shielding gas mixture is typically used, along with sufficient current and voltage to produce a stream of weld metal or a stream of weld droplets that cascade across an open arc from the electrode to the weld site. When weld droplets are evident, the droplets will be smaller than the diameter of the electrode utilized.

In globular transfer mode, an open arc process is used with a reactive gas, such as Ar or CO₂. Globular transfer mode utilizes less current and voltage than in spray transfer mode. The weld droplets generated are typically larger than the electrode diameter, and the globular weld droplet transfer is irregular.

In pulsed transfer mode, the pulse controls the droplet frequency across an electronically modified open arc. A peak weld current and background current are applied. This process enables an open arc mode of weld transfer of minuscule weld drops. This process can further provide controlled open arc weld transfer at considerably less current than with spray transfer mode.

To attach the refractory material to the surface of the vessel, the most common method used by installers is to stud weld or fillet weld threaded studs on the surface of the vessel and attach carbon steel or stainless steel anchors to the studs. The refractory material is attached to the anchors and the anchors are screwed on to the studs. More specifically, the common method used by installers is to stud weld or fillet weld threaded studs on the vessel by placing a metal stud having a machined protrusion tip in the stud gun. The stud is pressed against the surface of the vessel, and when the tip of the stud is in firm contact with the vessel, the stud gun trigger is pulled and a timed current is applied through the small protrusion tip at the end of the stud. The stud weld current melts the protrusion at the end of the stud tip and a high energy arc is generated between the stud and the grounded vessel. As the stud protrusion is melted, with the force applied to the stud gun, the stud is pushed tight against a ceramic shield located at the end of the stud. The ceramic shield assists in maintaining the necessary weld arc gap and also protecting the stud weld from the atmosphere. The timed weld arc melts the tip of the stud and with the manual force applied the stud is welded to the metal surface.

It is therefore desirable to provide a welding nozzle assembly and method of use thereof.

It is further desirable to provide an arc welding nozzle assembly having an upper guide body and a lower guide body configured to accurately insert and position the nozzle assembly between two adjacent arms of a V-shaped refractory anchor assembly.

It is still further desirable to provide a method of using the welding nozzle assembly to form a welding pool dam for attaching the V-shaped refractory anchor assembly to a surface.

It is further desirable to provide a welding nozzle assembly and method of use that provides a simplified and streamlined approach for attaching refractory anchors to a surface without the inclusion of a stud.

It is still further desirable to provide a welding nozzle assembly and method of use that provides a stronger and more consistent joint between a refractory anchor and the surface.

It is yet further desirable to provide a welding nozzle assembly and method of use for installing a refractory anchor to a surface that is practiced without the use of threaded studs, nuts or torque tubes, thereby reducing material costs and eliminating potential failure points.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### BRIEF SUMMARY OF THE INVENTION

In general, in a first aspect, the invention relates to a welding nozzle assembly having a nozzle body and an anchor guide assembly. The nozzle body may be generally cylindrical with an end surface configured to abut a seating surface of a refractory anchor. The anchor guide assembly includes an upper guide body and a lower guide body. The upper guide body has an alignment ridge intermediate of guides, and the lower guide body is in a spaced relation to the upper guide body. The anchor guide assembly is configured to accurately insert and position the nozzle assembly between two adjacent arms of the refractory anchor.

The nozzle body can be attached to or integrally fabricated with the anchor guide assembly. The lower guide body may have an upper planar guide face generally parallel with a lower planar guide face of the alignment ridge of the first guide body. The second guide body can be wider than the alignment ridge of the first guide body.

The nozzle assembly can also include a center guide body connected to the upper guide body and the lower guide body. The center guide body may be constructed of a guide stud or rod and a biasing spring. The guide stud or rod can pass through an aperture in the lower guide body and can be attached to the alignment ridge of the upper guide body. The spring of the center guide body biases the lower guide body towards the upper guide body.

In general, in a second aspect, the invention relates to an anchor guide assembly for a welding nozzle body. The nozzle body has an end surface configured to abut a seating surface of a V-shaped refractory anchor. The anchor guide assembly includes an upper guide body having an alignment ridge intermediate of a guide mechanism, a lower guide body in a spaced and movable relation to the upper guide body, and a center guide body connected to the upper guide body and the lower guide body. The center guide body has a guide stud or rod and a biasing spring for biasing the lower guide body towards the upper guide body. The guide stud or rod can pass through an aperture in the lower guide body and can be attached to the alignment ridge of the upper guide body. The anchor guide assembly is configured to accurately insert and position the nozzle assembly between two adjacent arms of the refractory anchor.

The nozzle body can be attached to or integrally fabricated with the anchor guide assembly. The lower guide body may have an upper planar guide face generally parallel with a lower planar guide face of the alignment ridge of the upper guide body. The lower guide body can be wider than the alignment ridge of the upper guide body.

In general, in a third aspect, the invention relates to a method of using the welding nozzle assembly of the first aspect and/or the second aspect above to attach a refractory anchor to a surface using a MIG spot plug weld. The refractory anchor may have a pair of V-shaped legs terminating at an arched attachment section that is generally perpendicular to the legs. The refractory anchor may also have a weld dam plate connected intermediate of the legs at or adjacent to the attachment section. The weld dam plate has a first or upper weld pool receptacle, a second or lower weld pool receptacle or both. The first weld pool receptacle and the second weld pool receptacle can be coaxially parallel and planarly aligned along the weld dam plate.

In general, in a fourth aspect, the invention relates to an anchor guide assembly for a welding nozzle body. The welding nozzle body has an end surface configured to abut a seating surface of a V-shaped refractory anchor. The anchor guide assembly includes a first guide body having an alignment ridge intermediate of a pair of spaced guide channels. The first guide body has a unitary tubular guide body attached to an outer diameter of the nozzle body. The anchor guide assembly also includes a second guide body in a spaced and movable relation to the first guide body. The second guide body has a guide channel configured to seat against the alignment ridge of the first guide body. Additionally, the anchor guide assembly includes a third guide body connected to the first guide body. The third guide body has a guide stud or rod engaged with the second guide body, and the third guide body is configured to bias the second guide body towards the first guide body.

The guide channel of the second guide body can have an upper planar guide face generally parallel with a lower planar guide face of the alignment ridge of the first guide body. Moreover, the guide channel of the second guide body can have a width greater than a width of the alignment ridge of the first guide body. Further, the guide stud or rod may pass through an aperture in the second guide body and can be attached to the alignment ridge of the first guide body.

In general, in a fifth aspect, the invention relates to an anchor guide assembly for a welding nozzle body. The anchor guide assembly has a first guide body with an alignment ridge intermediate of angled guide faces. In this aspect, the first guide body has a generally U-shaped channel attached to an outer diameter of the nozzle body. A second guide body of the guide assembly is in a spaced and movable relation to the first guide body, and the second guide body is configured to seat against the alignment ridge of the first guide body. The anchor guide assembly also includes a third guide body connected to the first guide body. The third guide body has a guide stud or rod engaged with the second guide body, and the third guide body is configured to bias the second guide body towards the first guide body.

The second guide body may have an upper planar guide face generally parallel with a lower planar guide face of the alignment ridge of the first guide body. In addition, the second guide body can have a width greater than a width of the alignment ridge of the first guide body. The guide stud or rod may pass through an aperture in the second guide body and be attached to the alignment ridge of the first guide body.

The foregoing has outlined in broad terms some of the more important features of the invention disclosed herein so that the detailed description that follows may be more clearly understood, and so that the contribution of the named inventors to the art may be better appreciated. The invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings, wherein:

FIG. 1 is a perspective view of an example of a prior art welding gun;

FIG. 2 is a cutaway of the nozzle body of the welding gun shown in FIG. 1;

FIG. 3 is a perspective view of an example of a welding assembly;

FIG. 4 is a perspective view of an example of a welding nozzle assembly in accordance with an illustrative embodiment of the invention disclosed herein;

FIG. 5 is a front elevation view of the welding nozzle assembly shown in FIG. 4;

FIG. 6 is a rear elevation view of the welding nozzle assembly shown in FIG. 4;

FIG. 7 is a side elevation view of the welding nozzle assembly shown in FIG. 4 in an engaged state;

FIG. 8 is a side elevation view of the welding nozzle assembly shown in FIG. 4 in a disengaged state;

FIG. 9 is a bottom elevation view of the welding nozzle assembly shown in FIG. 7;

FIG. 10 is a front perspective view of the welding nozzle assembly used in connection with a refractory anchor assembly in accordance with an illustrative embodiment of the invention disclosed herein;

FIG. 11 is a rear perspective view of the welding nozzle assembly used in connection with the refractory anchor assembly shown in FIG. 10;

FIG. 12 is a cross-sectional view along line 12-12 of the welding nozzle assembly shown in FIG. 5;

FIG. 13 is a perspective view of another example of a welding nozzle assembly in accordance with an illustrative embodiment of the invention disclosed herein;

FIG. 14 is a bottom elevation view of the welding nozzle assembly shown in FIG. 13;

FIG. 15 is a front elevation view of the welding nozzle assembly shown in FIG. 13;

FIG. 16 is a bottom perspective view of the welding nozzle assembly shown in FIG. 13;

FIG. 17 is a bottom perspective view of the welding nozzle assembly shown in FIG. 13 used in connection with a V-shaped refractory anchor assembly in accordance with an illustrative embodiment of the invention disclosed herein;

FIG. 18 is a rear perspective view of the welding nozzle assembly used in connection with the refractory anchor assembly shown in FIG. 17;

FIG. 19 is a front perspective view of the welding nozzle assembly used in connection with the refractory anchor assembly shown in FIG. 17;

FIG. 20 is a side elevation view of the welding nozzle assembly used in connection with the refractory anchor assembly shown in FIG. 17;

FIG. 21 is a perspective view of another example of a welding nozzle assembly having a protruding weld dam in accordance with an illustrative embodiment of the invention disclosed herein;

FIG. 22 is a front elevation view of the welding nozzle assembly shown in FIG. 21;

FIG. 23 is a side elevation view of the welding nozzle assembly shown in FIG. 21;

FIG. 24 is a top perspective view of the welding nozzle assembly shown in FIG. 21;

FIG. 25 is a side elevation view of the welding nozzle having the protruding weld dam shown in FIG. 21;

FIG. 26 is a top plan view of the welding nozzle shown in FIG. 25;

FIG. 27 is a bottom plan view of the welding nozzle shown in FIG. 25;

FIG. 28 is a perspective view of another example of a welding nozzle assembly in accordance with an illustrative embodiment of the invention disclosed herein;

FIG. 29 is a side elevation view of the welding nozzle assembly shown in FIG. 28;

FIG. 30 is a front elevation view of the welding nozzle assembly shown in FIG. 28;

FIG. 31 is a rear elevation view of the welding nozzle assembly shown in FIG. 28;

FIG. 32 is a top plan view of the welding nozzle assembly shown in FIG. 28;

FIG. 33 is a bottom plan view of the welding nozzle assembly shown in FIG. 28;

FIG. 34 is an exploded perspective view of the welding nozzle assembly shown in

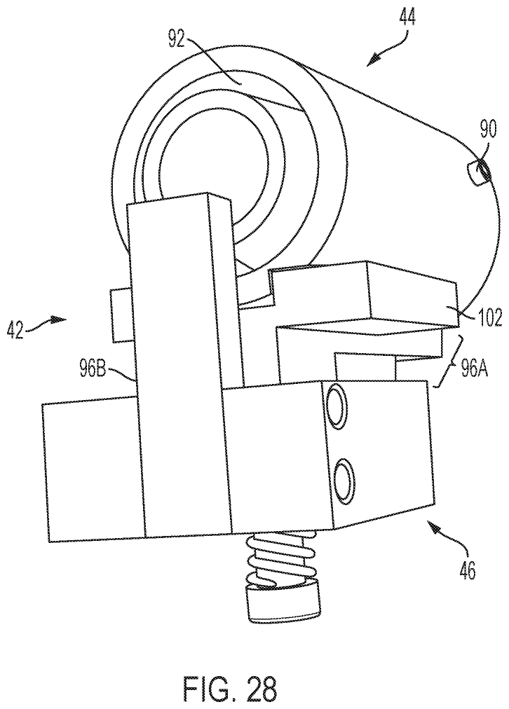

FIG. 28; and

FIG. 35 is a perspective view of the welding nozzle assembly shown in FIG. 28 used in connection with a V-shaped refractory anchor assembly in accordance with an illustrative embodiment of the invention disclosed herein.

### DETAILED DESCRIPTION OF THE INVENTION

While this invention is susceptible of embodiment in many different forms, there is shown in the drawings, and will herein be described hereinafter in detail, some specific embodiments of the invention. It should be understood, however, that the present disclosure is to be considered an exemplification of the principles of the invention and is not intended to limit the invention to the specific embodiments so described.

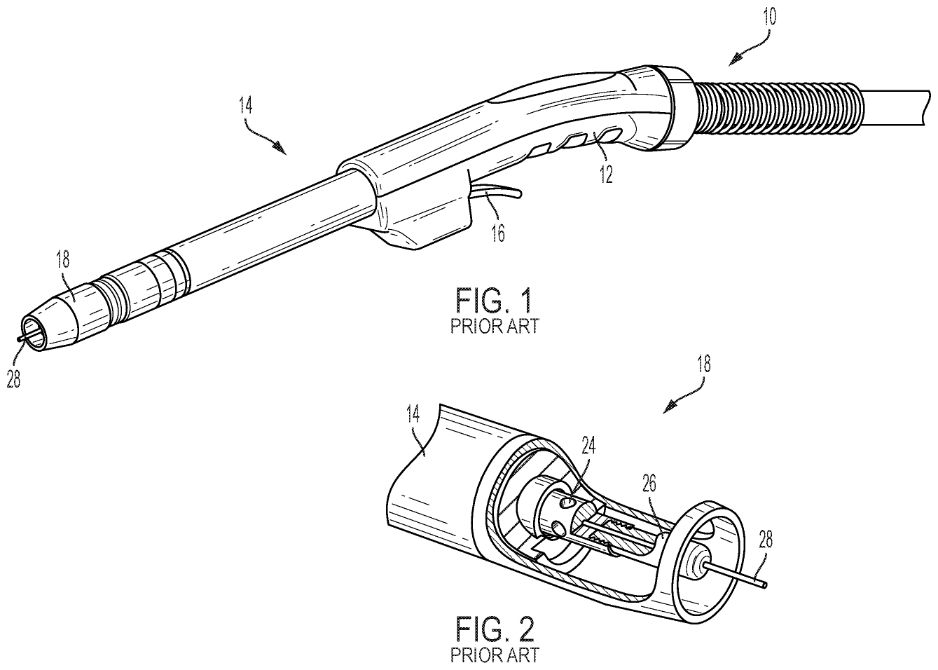

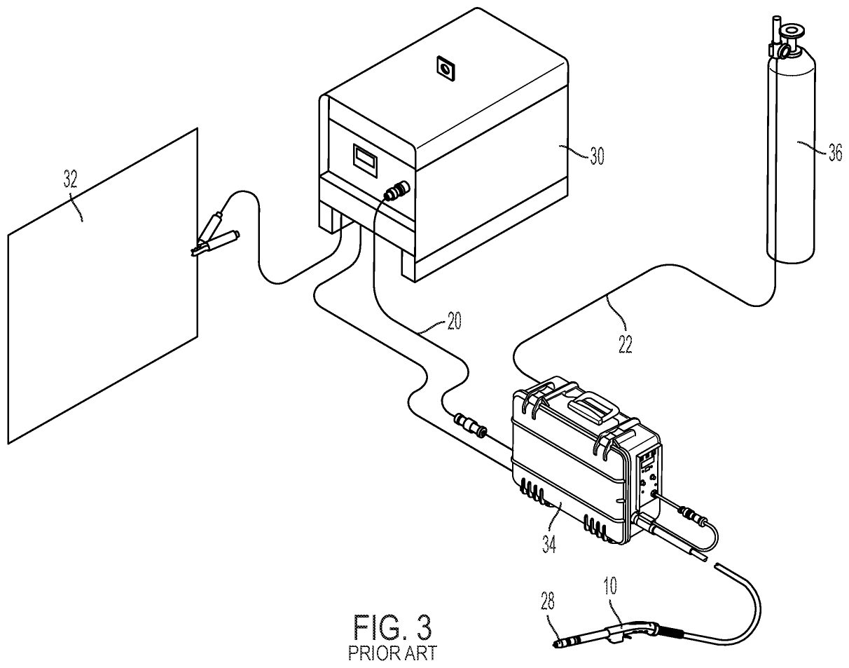

Referring generally to FIGS. 1 and 2, an exemplary metal inert gas (“MIG”) welding gun 10 is illustrated; however, the invention disclosed herein may be used with other wire feed welding systems. The welding gun 10 includes a handle 12, a neck 14, a control switch or trigger 16, a nozzle assembly 18, a power cable 20 and a gas hose 22. A gas diffuser 24 and a contact tip 26 are located within the nozzle assembly 18 of the welding gun 10. The nozzle assembly 18 is affixed at a terminal end of the neck 14 of the welding gun 10, opposite the handle 12. The welding gun 10, which can be a standard welding gun, a manual welding gun or a welding gun capable of variable speed, motorized drive rolls (i.e., a “push pull gun”), exerts a pulling force on an electrode 28 at the same time the electrode 28 is pushed from a wire feed unit 34. The nozzle assembly 18 of the welding gun 10 may be insulated in order to isolate the energized contact tip 26 from the nozzle assembly 18. The nozzle assembly 18 of the welding gun 10 may be constructed of brass or copper, and the welding gun 10 is connected to a suitable GMAW power source 30. The gas diffuser 24 of the welding gun 10 is in fluid communication with a source of shielding gas 36. The shielding gas flows through the gas hose 22 to the gas diffuser 24 of the welding gun 10.

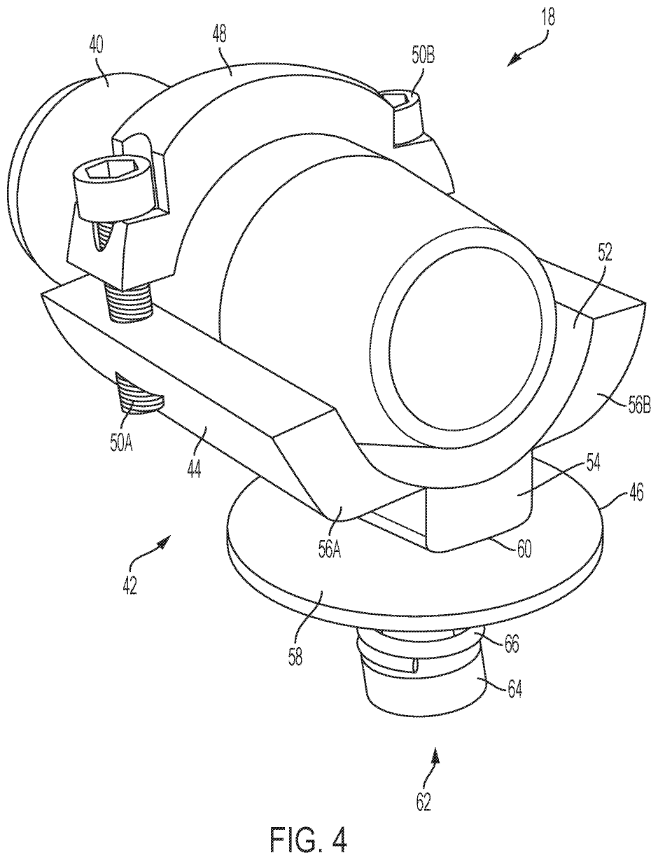

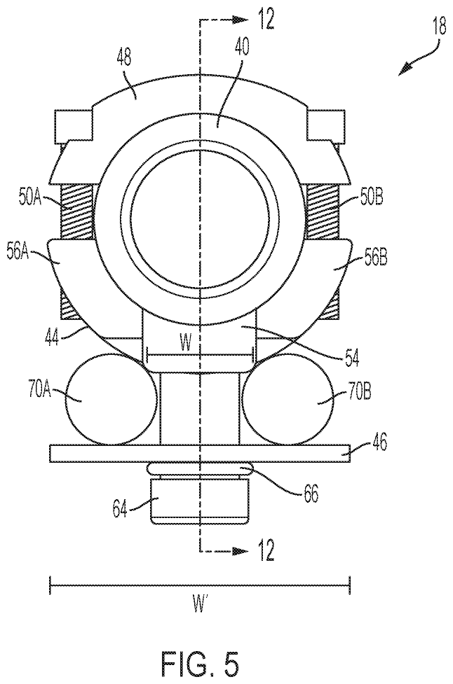

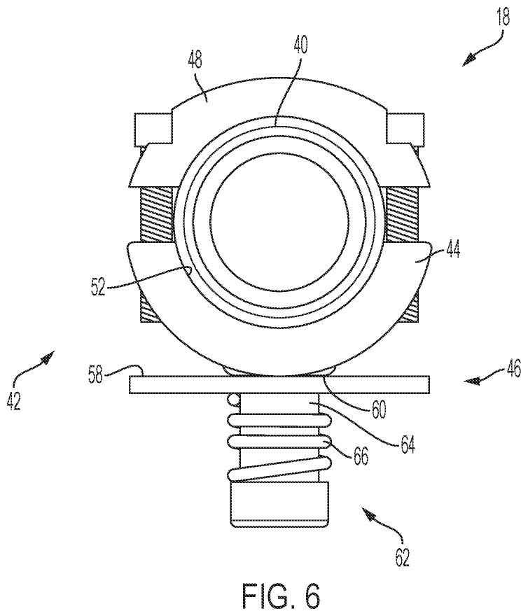

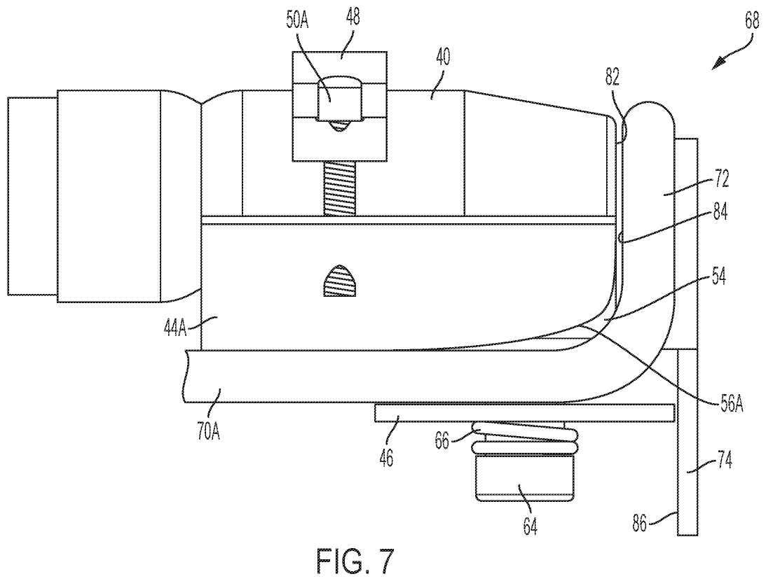

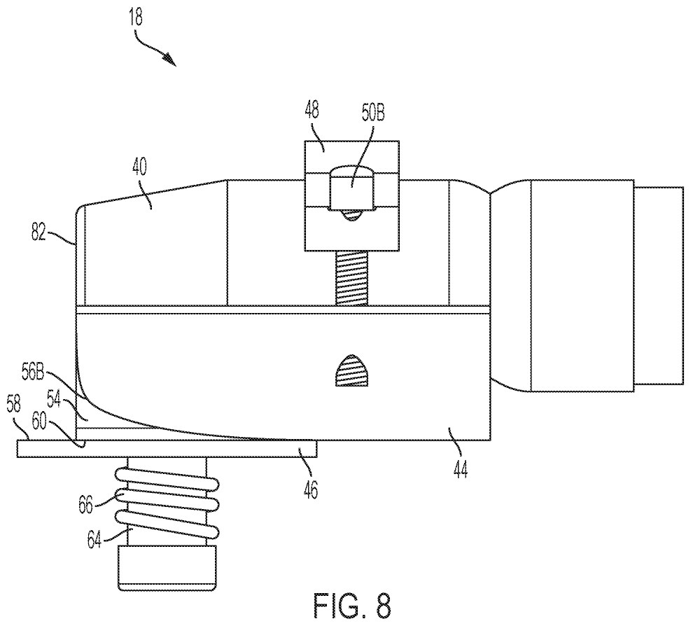

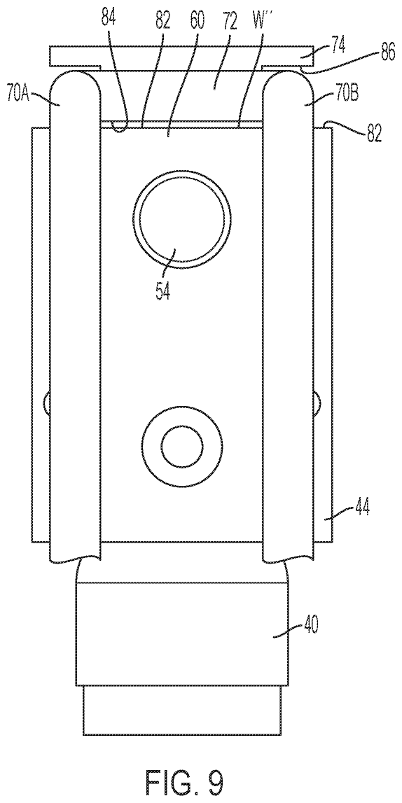

Turning now to FIGS. 4 through 9, the nozzle assembly 18 includes a nozzle body 40 and an anchor guide assembly 42. The anchor guide assembly 42 has a first or upper guide body 44 in a spaced relation to a second or lower guide body 46. The first guide body 44 can be attached to or integrally fabricated with the nozzle body 40. As shown in FIGS. 4 through 9 for purposes of exemplification rather than limitation, the first guide body 44 is attached to the nozzle body 40 using a saddle strap 48 using a pair of fasteners 50A/50B. The nozzle body 40 is seated within a generally U-shaped channel 52 in the first guide body 44. In addition, the first guide body 44 has an alignment ridge 54 intermediate of a pair of angled guide faces 56A/56B.

The second guide body 46 is spaced from and movable in relation to the first guide body 44. As illustrated, the second guide body 46 includes an upper planar guide face 58 that is generally parallel with a lower planar guide face 60 of the alignment ridge 54 of the first guide body. The second guide body has a width W′ greater than a width W of the alignment ridge of the first guide body 44.

The anchor guide assembly 42 can also include a third or center guide body 62. As illustrated, the third guide body 62 includes a guide stud or rod 64 that passes through an aperture in the second guide body 46 and is secured to the alignment ridge 54 of the first guide body 44. The second guide body 46 is biased toward the first guide body 44, such as using a helical biasing spring 66 wrapped around the guide stud 64 and secured between the first guide body 44 and the second guide body 46.

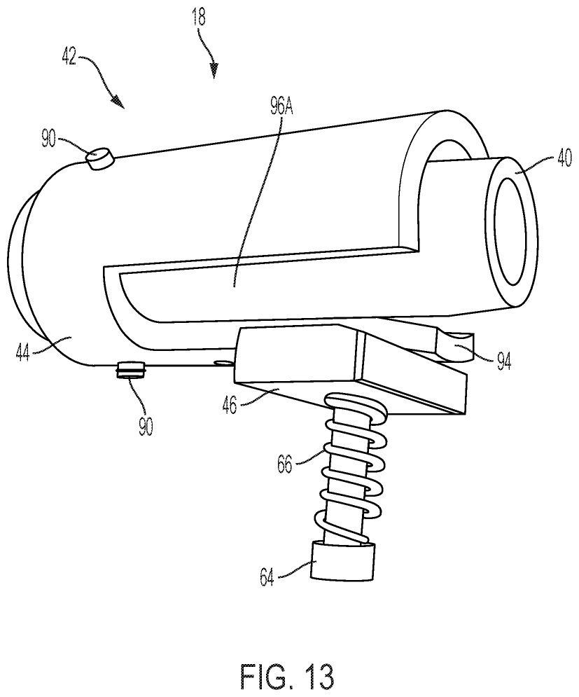

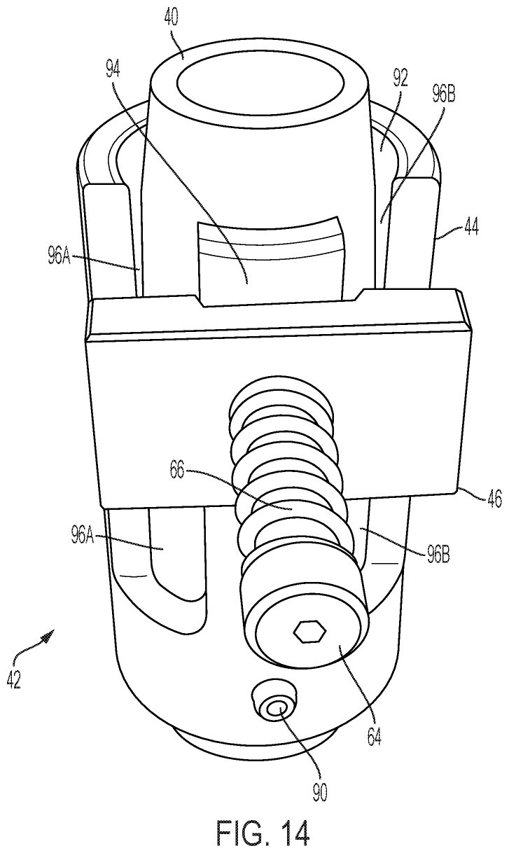

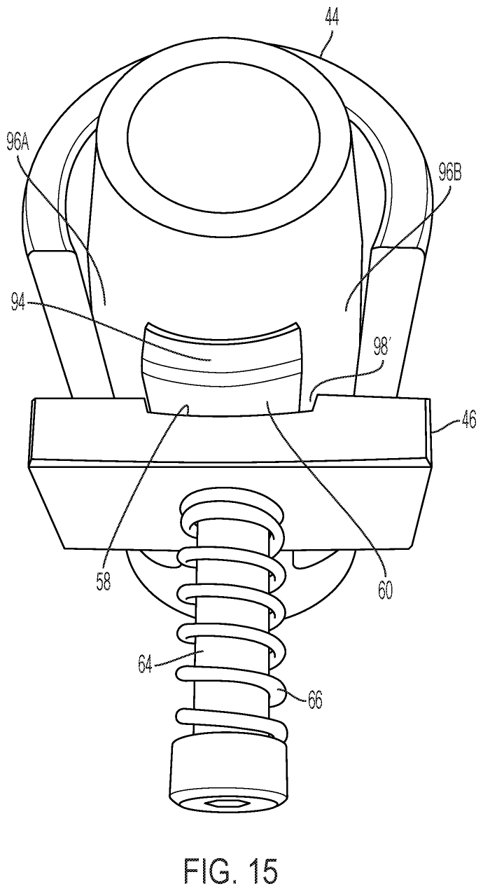

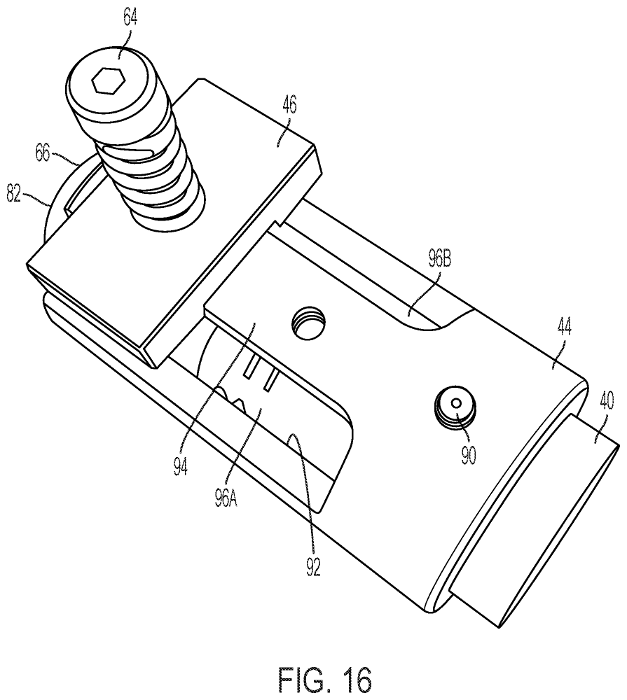

Turning now to FIGS. 13 through 16, the nozzle assembly 18 includes a nozzle body 40 and an anchor guide assembly 42. The anchor guide assembly 42 has a first or upper guide body 44 in a spaced relation to a second or lower guide body 46. The first guide body 44 can be attached to or integrally fabricated with the nozzle body 40. As shown in FIGS. 13 through 16 for purposes of exemplification rather than limitation, the first guide body 44 is a unitary tubular guide body attached to the outer diameter of the nozzle body 40 using fasteners 90. The nozzle body 40 is seated within a generally cylindrical channel 92 in the first guide body 44. In addition, the first guide body 44 has an alignment ridge 94 intermediate of a pair of guide channels 96A/96B.

The second guide body 46 is spaced from and movable in relation to the first guide body 44. As illustrated, the second guide body 46 includes a guide channel 98 having an upper planar guide face 58 that is generally parallel with a lower planar guide face 60 of the alignment ridge 94 of the first guide body 44. The guide channel 98 of the second guide body 46 has a width W′ that slightly larger a width W of the alignment ridge 94 of the first guide body 44.

The anchor guide assembly 42 can also include a third or center guide body 62. As illustrated, the third guide body 62 includes a guide stud or rod 64 that passes through an aperture in the second guide body 46 and is secured to the alignment ridge 94 of the first guide body 44. The second guide body 46 is biased toward the first guide body 44, such as using a helical biasing spring 66 wrapped around the guide stud 64 and secured between the first guide body 44 and the second guide body 46.

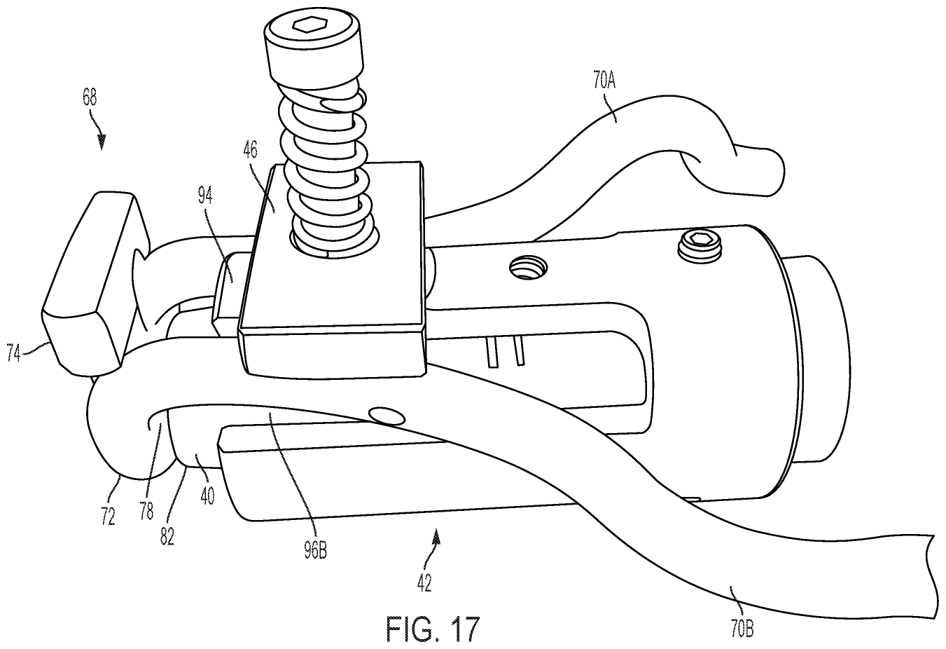

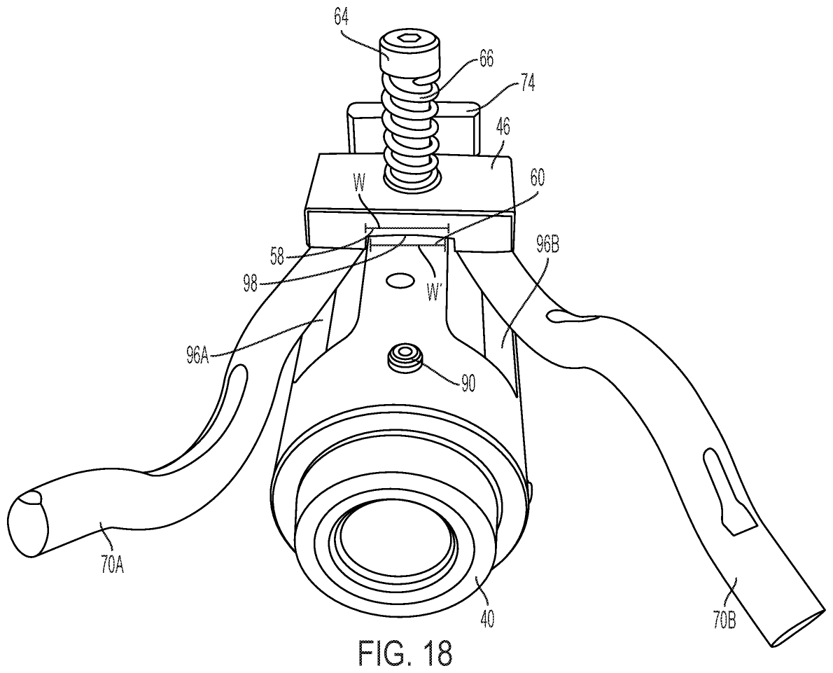

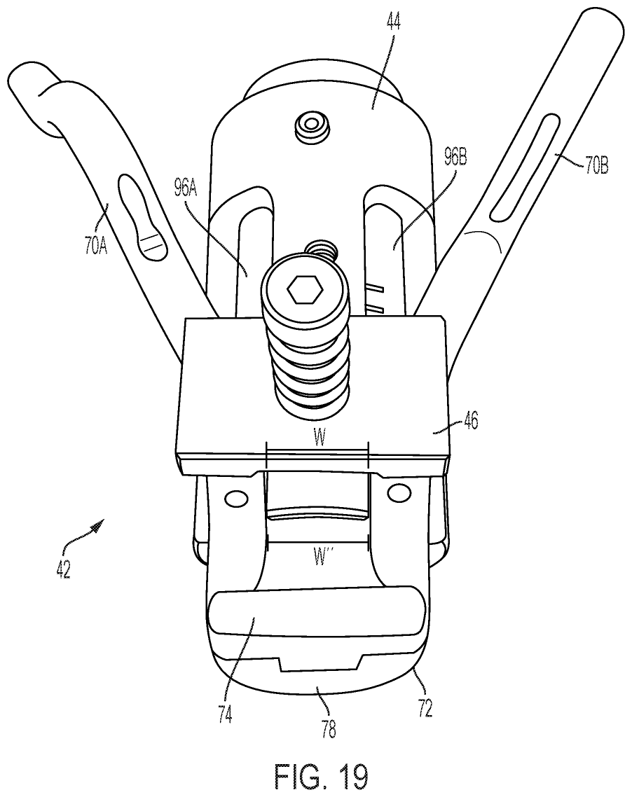

As illustrated in FIGS. 17 through 20, the second guide body 46 is biased away from the first guide body 44 in an engaged state, whereas the second guide body 46 is biased toward the first guide body 44 in a disengaged state as illustrated in FIGS. 13 through 16. The nozzle assembly 18 is configured for use with a refractory anchor assembly 68 having V-shaped legs 70A/70B. The legs 70A/70B of the refractory anchor assembly 68 terminate at an arched attachment section 72 that is generally perpendicular to the V-shaped legs 70A/70B. The refractory anchor assembly 68 is configured to be installed using MIG spot plug welds. A weld dam plate 74 is attached intermediate of the legs 70A/70B at or adjacent to the attachment section 72 of the refractory anchor assembly 68. The weld dam plate 74 has a pooling surface 76 forming a lower boundary of a first or upper weld pool receptacle 78. The weld dam plate 76 may optionally include a second or lower weld pool receptacle 80 positioned below the legs 70A/70B of the refractory anchor assembly 68. The first weld pool receptacle 78 and the second weld pool receptacle 80 are coaxially parallel and planarly aligned along the weld dam plate 76. The first weld pool receptacle 78 and/or the second weld pool receptacle 80 may be annular, ovate, rectangular, square or any other shape in cross-section. The opening size of the first weld pool receptacle 78 and/or the second weld pool receptacle 80 depends upon the particular welding application.

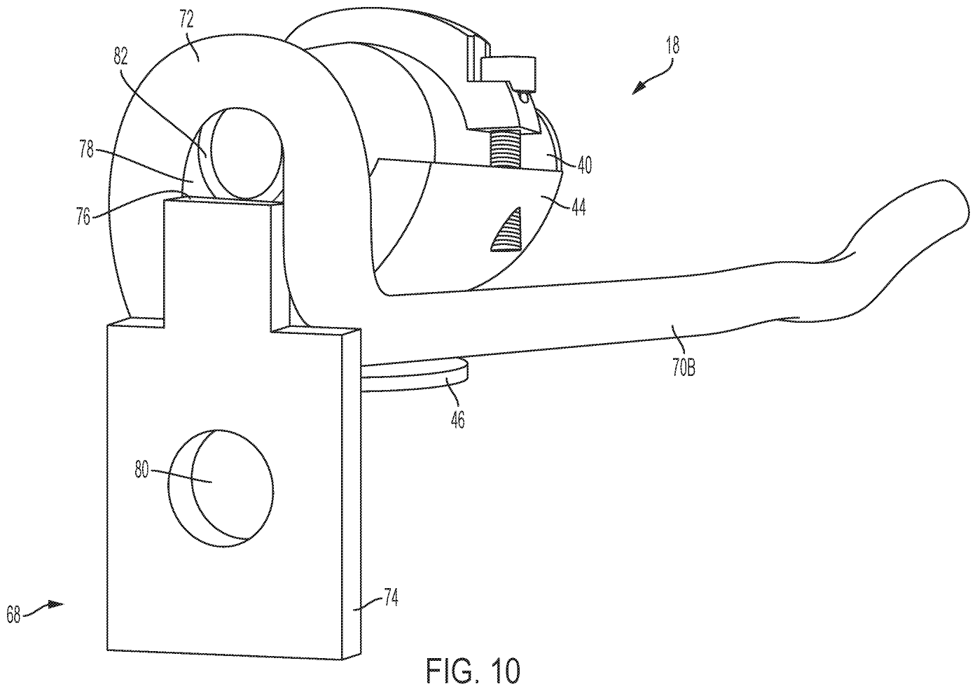

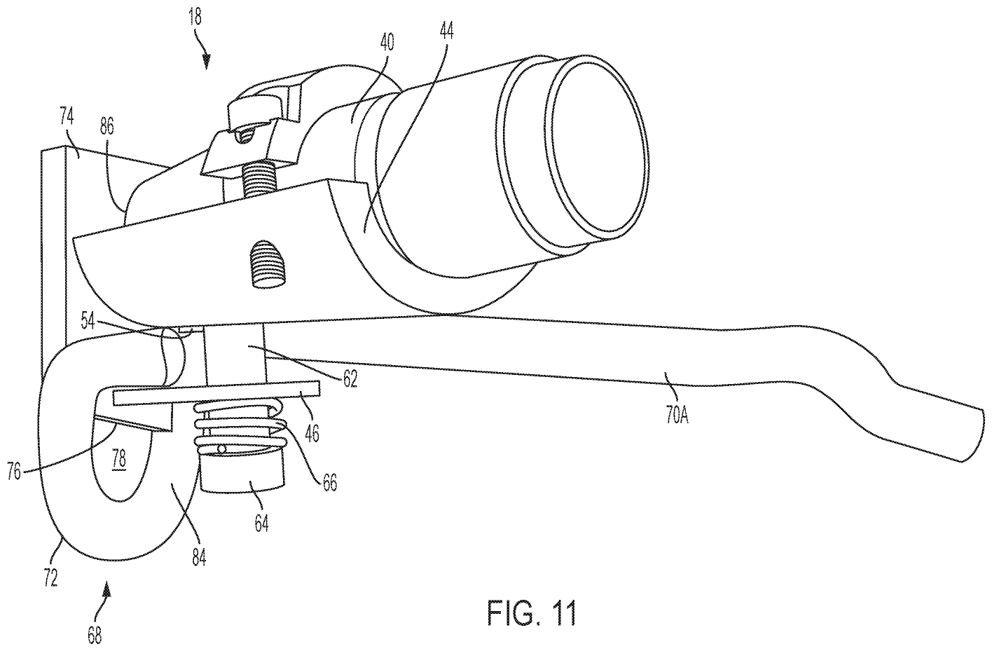

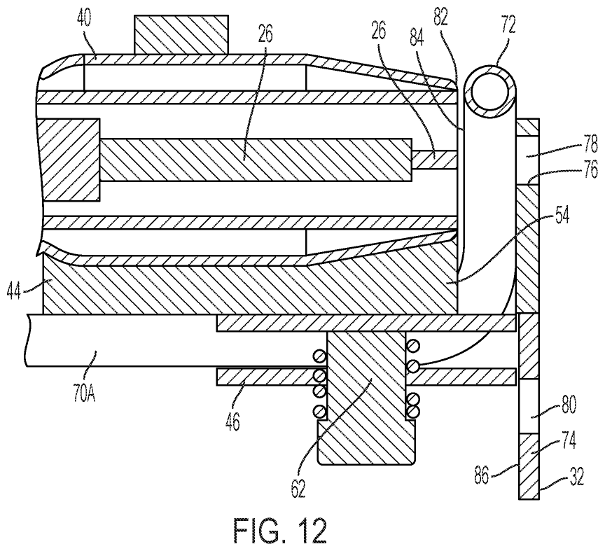

In general, during operation, an installer selectively positions the refractory anchor assembly 68 onto the surface 32 for attachment. As illustrated in FIGS. 10 through 12 and 17 through 20, to MIG spot plug weld the refractory anchor assembly 68 to the surface 32, the installer positions the alignment ridge 54 of the nozzle assembly 18 intermediate of the legs 70A/70B of the refractory anchor assembly 68, and as the installer advances the nozzle assembly 18 towards the attachment section 72 and the weld dam plate 74 of the refractory anchor assembly, the angled guide faces 52A/52B of the first guide body 44 respectively contact the legs 70A/70B. The angled guide faces 52A/52B direct the legs 70A/70B of the refractory anchor assembly 68 between the first guide body 44 and the second guide body 46, and as the nozzle assembly 18 is further advanced, the second guide body 46 is biased away from the first guide body 44 to the engaged state. Conversely, when the nozzle assembly 18 is withdrawn by the installer, the second guide body 46 is spring biased back toward the first guide body 44 to the disengaged state.

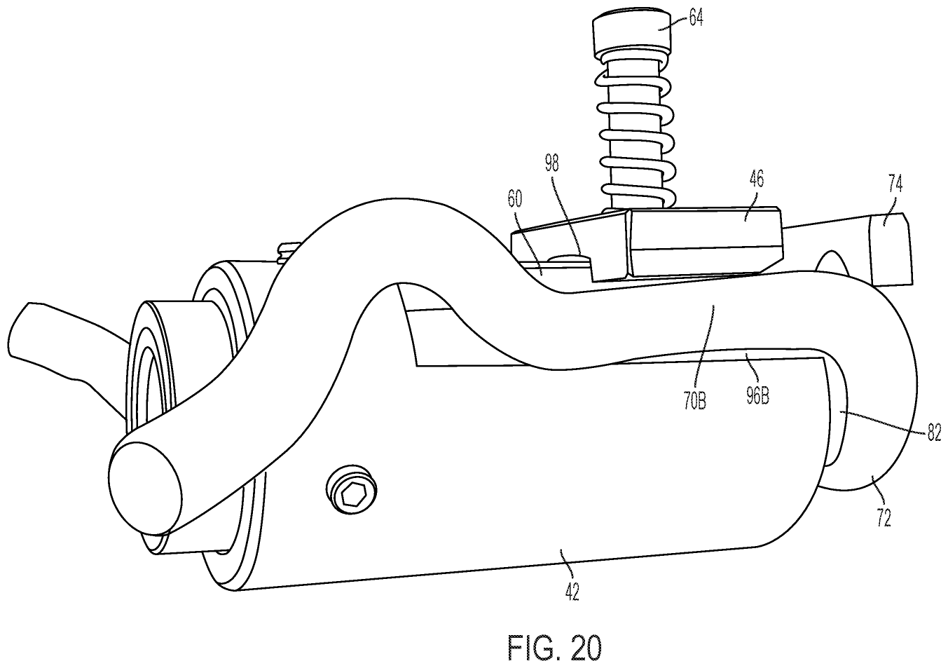

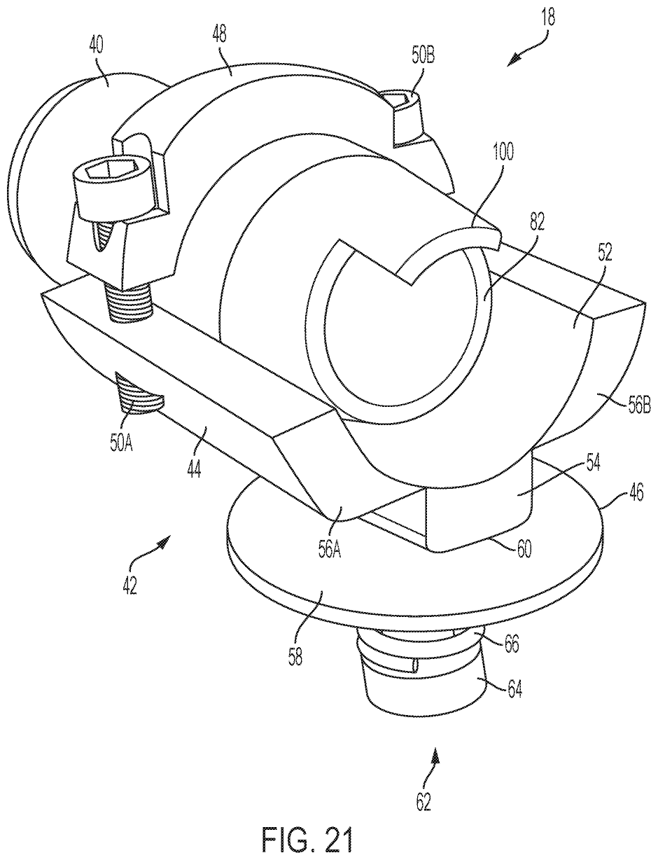

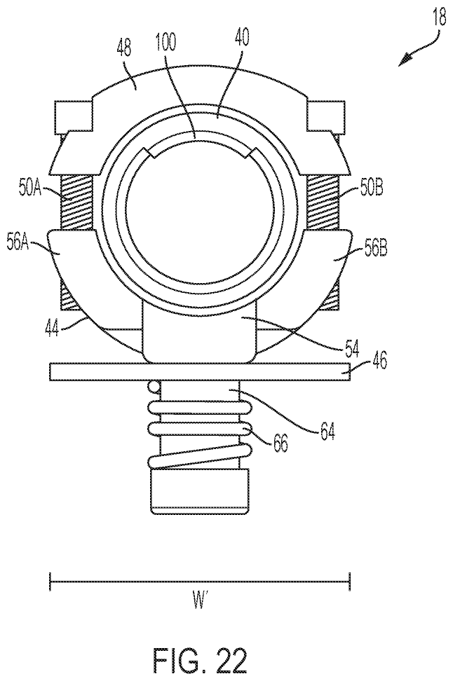

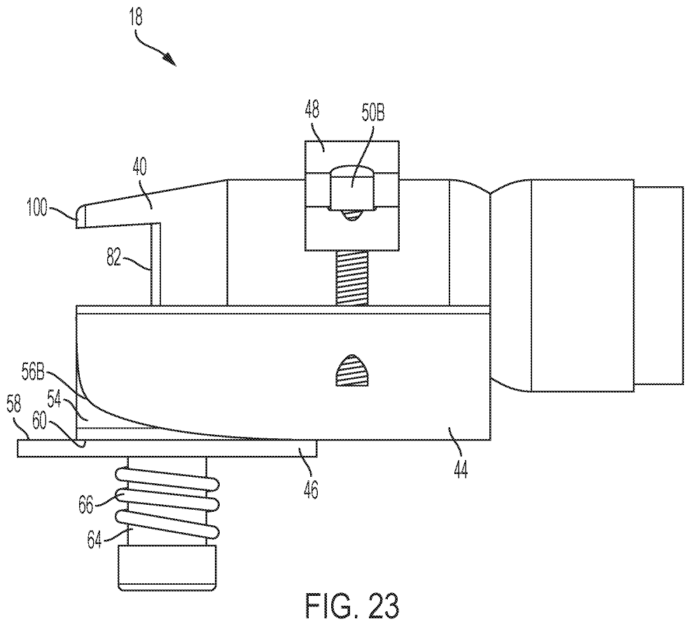

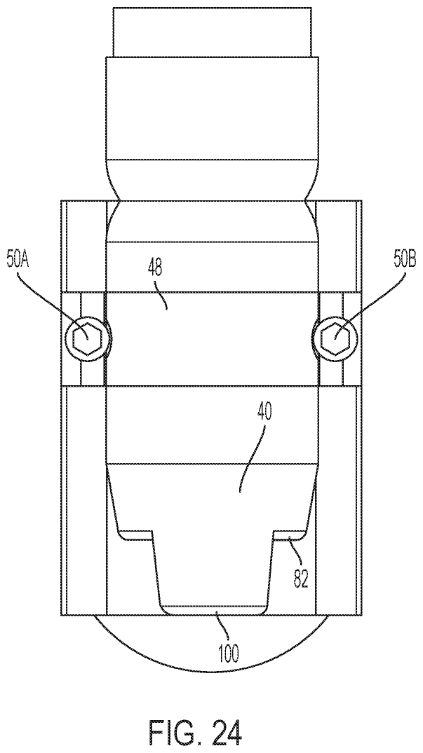

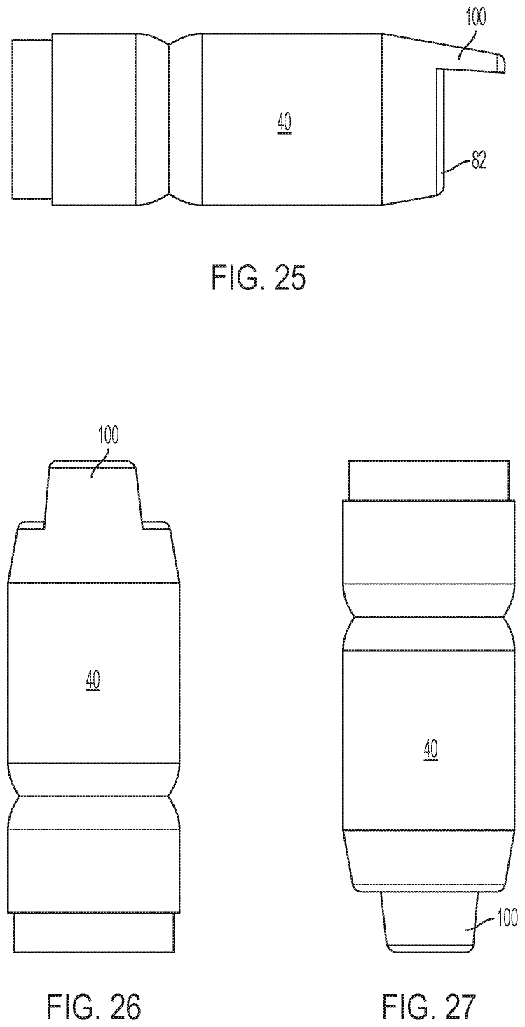

The nozzle assembly 18 of the welding gun 10 is has an end surface 82 that is adapted to abut a first or upper seating surface 84 and/or a second or lower seating surface 86 of the refractory anchor assembly 68. In the illustrated embodiments, the end surface 82 is uniform around the nozzle body 40. Alternatively, as exemplified in FIGS. 21 through 27, the end surface 82 of the nozzle body 40 has a protruding weld dam 100 adapted to abut a first or upper seating surface 84 and/or a second or lower seating surface 86 of the refractory anchor assembly 68. The first seating surface 84 of the refractory anchor assembly 68 surrounds the first weld pool receptacle 78, and the second seating surface 86 of the refractory anchor assembly 68 surrounds the second weld pool receptacle 80 for engagement of the nozzle assembly 18.

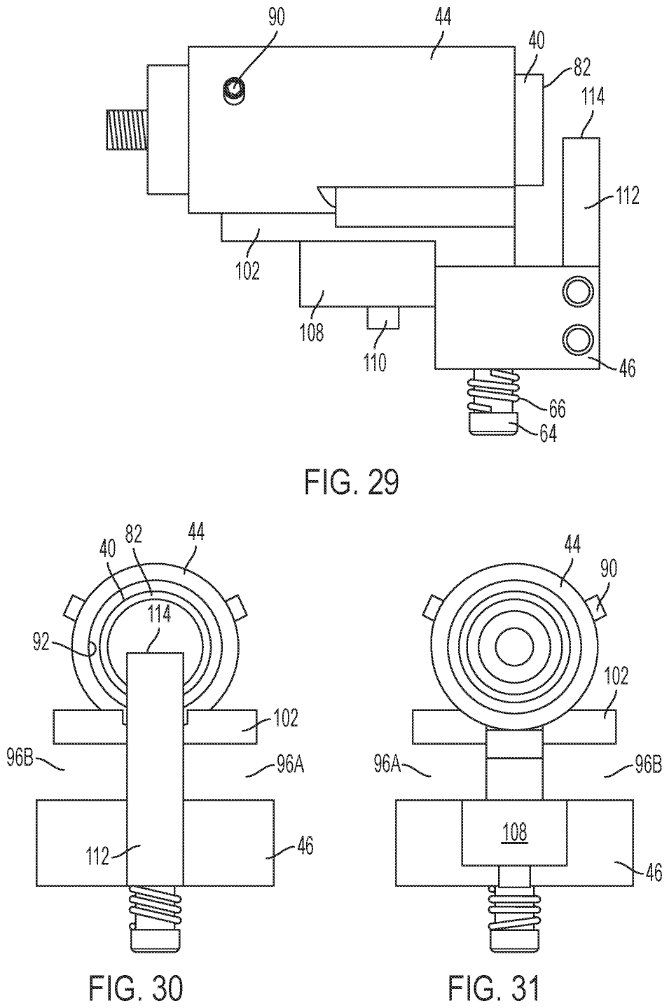

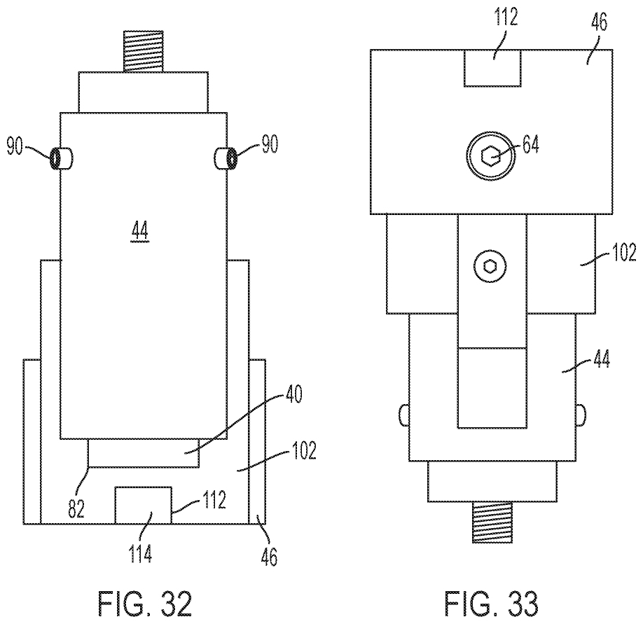

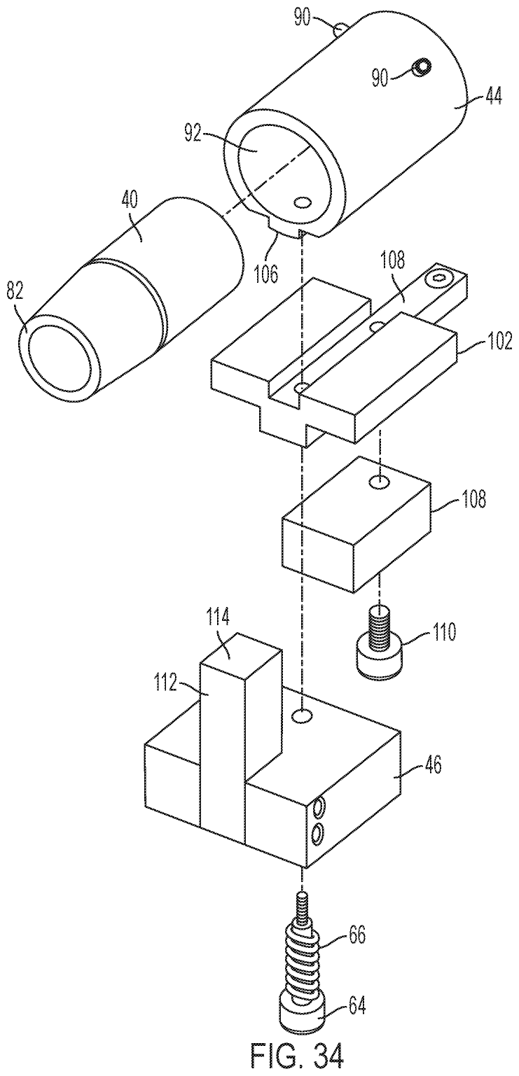

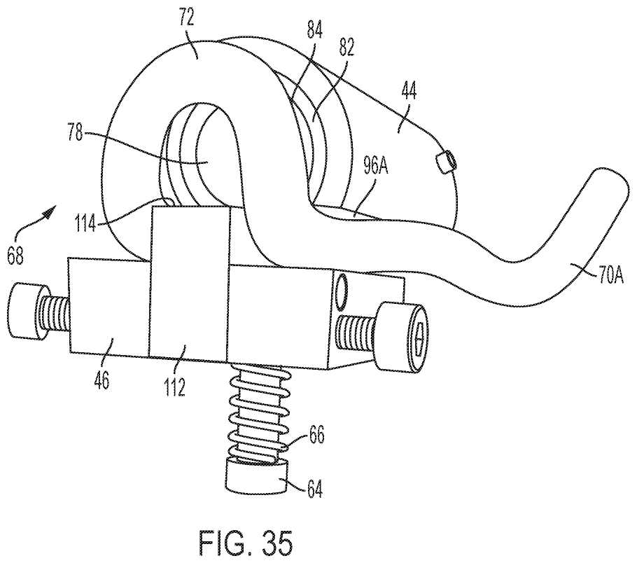

Referring now to FIGS. 28 through 35, the nozzle assembly 18 includes a nozzle body 40 and an anchor guide assembly 42. The anchor guide assembly 42 has a first or upper guide body 44 in a spaced relation to a second or lower guide body 46. As illustrated, the first guide body 44 is a unitary tubular guide body attached to the outer diameter of the nozzle body 40 using fasteners 90. The nozzle body 40 is seated within a generally cylindrical channel 92 in the first guide body 44. In addition, the first guide body 44 is secured to an alignment body 102 forming of a pair of guide channels 96A/96B with the lower guide body 46. The alignment body 102 includes a guide channel 104 for receipt of an alignment ridge 106 on a bottom portion of the first guide body 44.

The second guide body 46 is spaced from and movable in relation to the first guide body 44. As illustrated, the second guide body 46 is attached to a spacer body 108, which in turn is attached to the alignment body 102 of the first guide body guide 44 using fastener 110. The second guide body 46 includes a welding dam 112 positioned intermediate of the guide channels 96A/96B. The welding dam 112 forms a weld pooling surface 114 forming a boundary of the first weld pool receptacle 78 of the refractory anchor assembly 68. Similar to other embodiments, the guide stud or rod 64 passes through an aperture in the second guide body 46, through the alignment ridge 106 of the alignment body 102 and is secured to the bottom portion of the first guide body 44. The second guide body 46 is biased toward the first guide body 44, such as using the helical biasing spring 66 wrapped around the guide stud 64 and secured between the first guide body 44 and the second guide body 46.

When properly aligned for installation, the electrode 28, the nozzle assembly 18, the first weld pool receptacle 78, or the second weld pool receptacle 80, are generally coaxially aligned. The installer can depress the trigger 16 of the welding gun 10 in order to initiate the wire feed unit 54, to supply current and voltage from the power source 30 and a flow of shielding gas 36, resulting in an electric arc to be struck. The wire feed unit 34 supplies the electrode 28 to the welding gun 10 by driving it through an electrode conduit, which guides and protects the electrode 28, and onto the contact tip 26. The contact tip 26 of the welding gun 10 is connected to the power source 30 through a power cable 20 and transmits the electrical energy to the electrode 28 while directing it to the surface 32 and the refractory anchor assembly 68 to be welded. The contact tip 26 allows passage of the electrode 28 therethrough while maintaining contact with the refractory anchor assembly 68. The first weld pool receptacle 78 and/or the second weld pool receptacle 80 retain the MIG spot plug weld puddle for improved weld material filling and retention during installation of the refractory material assembly 68.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece.

For purposes of the instant disclosure, terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

Thus, the invention is well adapted to carry out and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A welding nozzle assembly, comprising:
a generally cylindrical nozzle body having an end surface configured to abut a seating surface of a V-shaped refractory anchor; and
an anchor guide assembly, comprising:
an upper guide body having an alignment ridge intermediate of guides;
a lower guide body in a spaced relation to said upper guide body;
wherein said anchor guide assembly is configured to accurately insert and position said nozzle assembly between two adjacent arms of said refractory anchor.

2. The nozzle assembly of claim 1 wherein said nozzle body is attached to said anchor guide assembly.

3. The nozzle assembly of claim 2 wherein said nozzle body is seated within a generally U-shaped or generally cylindrical channel in the upper guide body.

4. The nozzle assembly of claim 1 wherein said nozzle body is integrally fabricated with said anchor guide assembly.

5. The nozzle assembly of claim 1 wherein said guides of said upper guide body comprises guide channels or angled guide faces.

6. The nozzle assembly of claim 1 wherein said lower guide body further comprises an upper planar guide face generally parallel with a lower planar guide face of said alignment ridge of said first guide body.

7. The nozzle assembly of claim 1 wherein said lower guide body has a width greater than a width of said alignment ridge of said upper guide body.

8. The nozzle assembly of claim 1 further comprising a center guide body connected to said upper guide body and said lower guide body.

9. The nozzle assembly of claim 8 wherein said center guide body comprising a guide stud or rod and a biasing spring.

10. The nozzle assembly of claim 9 wherein said guide stud or rod passes through an aperture in said lower guide body and is attached to said alignment ridge of said upper guide body.

11. The nozzle assembly of claim 9 wherein said spring of said center guide body biases said lower guide body towards said upper guide body.

12. The nozzle assembly of claim 1 wherein said lower guide body further comprises a welding dam having a weld pooling surface.

13. An anchor guide assembly for a welding nozzle body, said nozzle body having an end surface configured to abut a seating surface of a V-shaped refractory anchor, said anchor guide assembly comprising:
an upper guide body having an alignment ridge intermediate of a guide mechanism;
a lower guide body in a spaced and movable relation to said upper guide body; and
a center guide body connected to said upper guide body and said lower guide body; said center guide body comprising a guide stud or rod and a biasing spring; said spring configured to bias said lower guide body towards said upper guide body;
wherein said anchor guide assembly is configured to accurately insert and position said nozzle assembly between adjacent arms of said refractory anchor.

14. The guide assembly of claim 13 wherein:
said nozzle body is being seated within a generally cylindrical or generally U-shaped channel in the upper guide body; and/or
said nozzle body is integrally fabricated with said anchor guide assembly; and/or
said lower guide body comprises a guide channel having an upper planar guide face generally parallel with a lower planar guide face of said alignment ridge of said upper guide body; and/or
said guide channel of said lower guide body has a width greater than a width of said alignment ridge of said upper guide body; and/or
said guide stud or rod passes through an aperture in said lower guide body and is attached to said alignment ridge of said upper guide body; and/or
said guide mechanism of said upper guide body comprises guide channels or angled guide faces; and/or
said lower guide body further comprises a welding dam having a weld pooling surface.

15. A method of using the welding nozzle of claim 1 to attach said refractory anchor to a surface using a MIG spot plug weld, wherein said refractory anchor comprises:
a pair of V-shaped legs terminating at an arched attachment section that is generally perpendicular to said legs; and
a weld dam plate connected intermediate of said legs at or adjacent to said attachment section of said refractory anchor; said weld dam plate having a first or upper weld pool receptacle, a second or lower weld pool receptacle or both.

16. The method of claim 15 wherein said first weld pool receptacle and said second weld pool receptacle are coaxially parallel and planarly aligned along said weld dam plate.

17. The guide assembly of claim 1, further comprising:
an anchor guide assembly for a welding nozzle body, said welding nozzle body having an end surface configured to abut a seating surface of a V-shaped refractory anchor, said anchor guide assembly comprising:
a first guide body having a welding dam having a weld pooling surface; said first guide body comprising a unitary tubular guide body or a generally U-shaped channel attached to an outer diameter of said nozzle body;
a second guide body in a spaced and movable relation to said first guide body; and
a third guide body connected to said first guide body; said third guide body comprising a guide stud or rod engaged with said second guide body; said third guide body configured to bias said second guide body towards said first guide body.

18. The guide assembly of claim 17 further comprising:
said first guide body comprising an alignment ridge intermediate of a pair of spaced guide channels; and
said second guide body comprising a guide channel configured to seat against said alignment ridge of said first guide body; and/or
wherein said guide channel of said second guide body has an upper planar guide face generally parallel with a lower planar guide face of said alignment ridge of said first guide body; and/or
wherein said guide channel of said second guide body has a width greater than a width of said alignment ridge of said first guide body; and/or
wherein said guide stud or rod passes through an aperture in said second guide body and is attached to said alignment ridge of said first guide body.

19. The guide assembly of claim 1, further comprising:
an anchor guide assembly for a welding nozzle body, said welding nozzle body having an end surface configured to abut a seating surface of a V-shaped refractory anchor, said anchor guide assembly comprising:
a first guide body having an alignment ridge intermediate of angled guide faces;
a second guide body in a spaced and movable relation to said first guide body; said second guide body configured to seat against said alignment ridge of said first guide body;
a third guide body connected to said first guide body; said third guide body comprising a guide stud or rod engaged with said second guide body; said third guide body configured to bias said second guide body towards said first guide body; and
wherein said first guide body, said second body or both have a welding dam with a weld pooling surface.

20. The guide assembly of claim 19 further comprising:
wherein said second guide body has an upper planar guide face generally parallel with a lower planar guide face of said alignment ridge of said first guide body; and/or
wherein said second guide body has a width greater than a width of said alignment ridge of said first guide body; and/or
wherein said guide stud or rod passes through an aperture in said second guide body and is attached to said alignment ridge of said first guide body.
